(19) United States
(12) Patent Application Publication
(10) Pub. No.: US 2005/0075166 A1
(43) Pub. Date: Apr. 7, 2005

(54) Media program with interactive feature

(76) Inventors: Paul A. Hemstreet, Valencia, CA (US); Ezra J. Greene, Los Angeles, CA (US); Bradley Thomas Collar, Valencia, CA (US)

Correspondence Address: Brian M. Berliner;O'MELVENY & MYERS LLP, 400 South Hope Street, Los Angeles, CA, 90071-2899, US

(21) Appl. No.: 10/437,710

(22) Filed: May 14, 2003

Related U.S. Application Data
(60) Provisional application No. 60/380,674, filed on May 14, 2002.

(51) Int. Cl. A63F 13/00

(52) U.S. Cl. 463/30

(57) ABSTRACT

A method for playing an interactive game uses a DVD-Video player, a display device, and appointing device. The DVD player plays a first video segment, that includes an animated element moving through different regions of the video display. The DVD player receives pointing input from the pointing device, causing a corresponding region of the display to become active. A user may send an interruption command to the DVD player. Play of the first segment may continue until an interruption command is received when the animated element is in an active region of the video display. When this occurs, the DVD player interrupts the first video segment and plays a second segment. The method may be repeated for successive levels of game play.

### CROSS-REFERENCE TO RELATED APPLICATION

This application claims priority pursuant to 35 U.S.C. § 119(e) to U.S. Provisional Application No. 60/380,674, filed May 14, 2002, which application is specifically incorporated herein, in its entirety, by reference.

### COPYRIGHT NOTICE

This patent document contains material subject to copyright protection. The copyright owner, Time Warner Entertainment Company LP, has no objection to the reproduction of this patent document as it appears in the files of the Patent and Trademark Office of the United States or any other country, but otherwise reserves all rights whatsoever.

### BACKGROUND OF THE INVENTION

1. Field of the Invention

The present invention relates to methods and systems for producing and playing media programs, and more particularly to a media program, such as a DVD program, with an interactive feature for providing a video game-like interactive experience.

2. Description of Related Art

The growth in new forms of digital media has led to numerous opportunities to change the method by which audio-visual and like productions are produced and played. Prior to the rise of digital media, analog media programs typically consisted of a continuous stream of audio-visual information sequentially recorded in a medium such as a photographic film or magnetic tape. To play such analog programs, the recording medium is sequentially scanned by a reading and/or projection device-to recreate the recorded program in the intended display format, such as on a movie or television screen. In the analog environment, there can be no video game-like interaction between a viewer and the media program. All the elements of the recorded program are played in sequence according to the timing and sequence of the original recording, and the opportunity to interact with the video stream is limited to executing functions such as pause (freeze-frame), fast-forward, and reverse.

Certain digital media standards, however, provide for expanded capabilities that permit limited interactivity between a viewer and a media program. For example, expanded features such as branching, multiple camera angles, parental control, video menus, and interactive buttons are supported by the DVD-Video standard available from the DVD Forum (www.dvdforum.org). Other digital media standards exist. In general, digital media standards support at least a degree of interactivity and control sufficient to permit control of the sequence and timing of selected media segments or frames during playback. In particular, the DVD-Video standard has become prevalent, and media products that include the expanded features listed above are commonly available based on the DVD-Video standard. Such features, however, do not exhaust the possibilities within the DVD-Video standard or other existing or prospective standards. It is desirable to provide additional features to increase consumer interest in media products such as DVD-Video discs, thereby inducing consumers to purchase such products in greater numbers and at more favorable prices.

In particular, prior DVD-Video programs have lacked any video game-like features that permit interactivity between a viewer and an animated on-screen element. Instead, prior art interactive games in DVD formats have been limited to selection of commands using static buttons and icons. It is therefore desirable to provide an interactive, dynamic feature that may be implemented in a DVD-Video format, and that provides for more dynamic interaction between a viewer and an animated element comparable to that provided by video games and the like.

### SUMMARY OF THE INVENTION

The present invention provides additional features for increasing consumer interest in a recorded media product. In particular, the invention provides a method and system for producing or playing a media program with an interactive feature for providing a video game-like interactive experience. The invention is particularly suitable for implementation within the DVD-Video standard, and may therefore be used with special-purpose media players such as DVD video players.

Programs produced according to the DVD-Video standard for play on a special purpose DVD player are distinct from programs produced for more general computing environments, such as programs produced according to the DVD-ROM standard for play on the DVD player of a general-purpose computer. Because it is designed to produce programs that can be processed using a general-purpose microprocessor, as opposed to a specialized video chip as found in specialized DVD players, the DVD-ROM standard provides greater interactivity and more versatility than is possible under the DVD-Video standard. The present invention applies to programs produced according to a DVD-Video standard and like standards, if any, for specialized media, players. In the specialized video environment, the present invention provides the benefit of emulating features heretofore found only in media programs produced under more versatile standards for computing or video game environments.

The invention provides a media program configured for play on a media player to produce an audio-visual stream that provides an interactive feature similar to those of video games. The interactive feature comprises at least one animated element that continuously moves over a predetermined background. As it moves across the background, the animated element enters and exits different regions of the background according to a predetermined sequence. The sequence may be configured so that the motion of the animated element appears to be random to a viewer of the program. While the animated element moves across the background, a viewer can “chase” the element by using control keys, such as cursor keys on a controller for the media player, to follow the moving element by highlighting a region as the animated element moves into it. By activating another command of the controller (such as by pressing an “enter” button) while the animated element is in a highlighted region, a viewer of the program can “catch” the animated element. When the animated element is “caught,” the video of the animated element is interrupted by a predetermined video sequence that in essence rewards a successful catch of the animated element, or moves the game to a higher level.

According to an embodiment of the present invention, the animated element and background are provided in a video layer of the media program. A mask comprising a graphic overlay is provided in a sub-picture layer over the video layer. The graphical mask may be given a,translucent, meshed, or speckled appearance, so as to only partially obscure the video layer. A button layer is provided over the sub-picture layer and video layer. The button layer comprises a 2-dimensional array or map of button elements, each covering a region of the sub-picture mask. Each button element of the array is configured to be highlighted in response to a user-selection command that may be input by a user using a control device, such as the remote control unit for a DVD player. The button layer is configured so that when a button element is highlighted, the mask region that it covers becomes visible at all other times, the mask region covered by the button element is invisible.

The button layer is further configured so that each button element is assigned a navigation command for interrupting the video sequence and playing a second sequence when the button element contains the animated element. This may be done by synchronizing the activation of the desired menu command in the button element with the motion of the animated element, such as by using a suitable authoring system. In such case, the user may activate the navigation command by highlighting and selecting the button element only at such times as the animated element is in the region covered by the button element. At other times, each button element is assigned a null command that does not affect play of the video stream.

A more complete understanding of the media program with selectable sub-segments will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a diagram showing an exemplary system for playing an interactive media program according to the invention.

FIG. 2 is a flow diagram showing exemplary steps of a method for playing an interactive media program.

FIG. 3 is a flow diagram showing exemplary steps of a method for producing an interactive video program.

FIG. 4 shows an exemplary video frame from a media program having an animated element according to the invention.

FIG. 5 shows an exemplary video frame of the program shown in FIG. 4, with the animated element in a region of the screen covered by a highlighted button.

FIG. 6 shows an exemplary video frame of a video segment that is played when a navigation command of the highlighted button shown in FIG. 5 is activated by a user.

FIG. 7 shows the video frame of FIG. 4, with the overlaying button layer revealed.

FIG. 8 is a diagram showing the relationship of elements of a game feature program according to the invention.

FIG. 9 is an screen shot showing a game feature, program in the process of being developed using exemplary authoring software.

FIG. 10 is a diagram showing, an exemplary structure of information encoded on an optical media.

FIG. 11 is a diagram showing an exemplary structure of information encoded on an optical media according to an alternative embodiment of the invention.

FIG. 12 is a diagram showing an exemplary structure of information encoded on an optical media according to an alternative embodiment of the invention.

FIG. 13 shows an exemplary display during play of a program according to the invention, displaying indicators of a level of play and of a score.

### DETAILED DESCRIPTION OF THE PREFERRED EMBODIMENT

The present invention provides a media program with an interactive feature that permits interaction between a viewer and an animated on-screen element. The media program is, particularly suitable for implementation in digital formats such as DVD-Video, and the like. In the detailed description that follows, like element numerals are used to indicate like elements appearing in one or more of the figures.

A media program according to the invention may be played according to a method of the invention using a system 100, shown in FIG. 1. In summary, system 100 comprises a digital media 102 comprising an encoded interactive media program, a media player 104 for playing the encoded media program, a display 103 for displaying the media program as it plays, and a pointing device 108 for providing pointing input to the media player 104. System 100 may be embodied using various different articles or devices. One familiar embodiment includes a media 102 in the form of a DVD disc, that may be played in a DVD-disc media player 104, that is connected to a display 106 in the form of a television screen or video display monitor, and receives pointing input from a pointing device 108 comprising an array of arrow keys or joystick on a remote control device. Various other embodiments of system 100 as known in the art, some of which are disclosed in the detailed description that follows, may also fall within the scope of the invention.

One of the objects of the invention is to produce an interactive media program that may be encoded for writing to a digital media 102, such as a DVD disc. Like the authoring system, the encoder may comprise a general, purpose computer running commercially available encoding software. Encoding may be done in various formats. For current DVD applications, the preferred format is MPEG-2, although other formats, such as MPEG-1, MPEG-2 Progressive Profile, H.263, or MPEG-4 may be used. Likewise, the digital media 102 may be of various forms. Presently, a common digital media is digital video disc (DVD). However, alternative media, such as digital tape, HD-DVD, or FMD (fluorescent multi-layer disc), or any other suitable storage media, may be used if desired. The encoded data may optionally be encrypted, as known in the art.

The digital media 102 with its encoded interactive media program may be played using an appropriate media player 104. Typical media programs for movie videos require well in excess of 1 gigabyte of storage space after being encoded, and are often played using dedicated media players such as DVD video players. Media players are currently available to read digital media formatted according to various standards, including DVD-Video, DVD-Audio, and audio CD. The media player 104 outputs a signal for a suitable display device 106, such as a television configured to accept a video signal according to a 525/60 (NTSC) or 625/50 (PAL/SECAM) standard, for viewing by a user. Alternative display devices may include CRT's, passive matrix flat panel displays, active matrix flat panel displays, or CRT projection systems, coupled to appropriate electronics for receiving any suitable video signal and processing the signal for creating a video display on the display device.

The digital media 102, media player 104, and display device 106 of system 100 need not be physically near each other. In the case of a present-day DVD videodisc player, these elements are usually near each other. However, these elements may be separated by great distances if connected by a signal of sufficient bandwidth. For example, the digital media may be located at a remote site, and the encoded media program may be streamed to a media player at the user's location. In the alternative, both the media player and the digital media may be located remotely, and the video signal streamed or transmitted to the output device at the user's location. In the latter case, the user communicates with the media player via a remote connection.

Finally, pointing device 108 may,comprise any suitable input device connected to media player 104, for sending a control signal or commands to the media player. In particular, the pointing device provides an input that may be used to point or move a graphical pointer, such as a cursor, to a desired screen location of display 106. For example, a computer mouse, track ball, or joy stick are all examples of pointing devices. More typically in combination with DVD videodisc players, the pointing device 108 may; comprise a remote, handheld control device with numerous command keys, such as volume control, “play,” “pause,” “enter,” as so forth, as known to one of ordinary skill. Such remote controllers often include an array of arrow keys, such as “Left,” Right,” “Up,” and “Down” keys. The arrow keys may be used to provide directional input (i.e., pointing input) to the media, player, in a manner similar to a mouse or trackball.

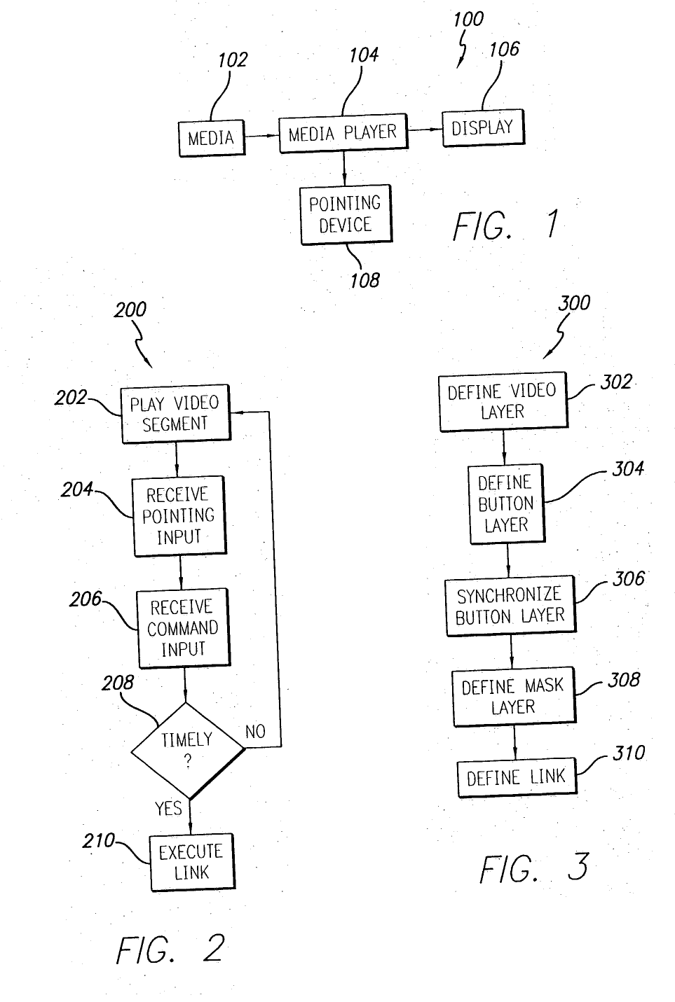

Using any such suitable system 100, a method 200 for playing an interactive media program may be played, exemplary steps of which are shown in FIG. 2. At step 202, a video segment according to the invention is played using any suitable method according to the invention. The video segment includes at least one animated element moving through different regions of the display screen. A “video segment” is any discrete portion of a media program, comprising a defined sequence of video frames. A video segment has a defined duration, but also may be played as an endless loop of indefinite duration. It may also be interrupted at different times in the sequence, or play may be started at different times of the sequence. The invention is not concerned with the particular manner in which a video segment is repeated, interrupted, or begun; nor with the particular way in which its limits are defined. One of ordinary skill will recognize the term “media segment” as a flexible term that is most clearly delineated at the production level. Conversely, at different times during play of a media program, different portions of the same segment may appear at different times, and a program does not necessarily comprise the same unvarying sequence of segments each time it is played.

The video segment played at step 202 contains certain special elements according to the invention. Briefly, these special elements cause the media player 104 to interact with a viewer in certain novel ways, as described below. Exemplary special elements according to an embodiment of the invention are also described in more detail later in the specification. Method 200 may be performed using a media encoded according to the DVD-Video standard as described below, or any other equivalent scheme. At step 204, the media player receives a pointing input from a viewer of the video segment. The pointing input indicates a desired motion for a cursor or like element on the video display. By providing pointing input, the viewer is able to highlight or otherwise indicate a desired region of the display screen. The media player reacts to the pointing input by highlighting (or otherwise indicating) a corresponding selected region of the display screen.

At step 206, the media player receives a command input. The command input may be provided by the viewer using any desired button or other actuator of a control panel, such as a button of a remote control panel. At step 208, the media player determines whether the received command is timely. This determination is done using three input parameters: the type of command received, the display region currently selected by the viewer using the pointing input, and the geometric relationship between the animated element and the selected region. For example, if after first determining that the command is an interrupt command, the media player may determine if the animated element is within the currently selected region. If so, the video segment is interrupted and play of a linked segment may begin instead, at step 210. If not, play of the video segment continues at step 202.

Method 200 may be performed in essentially the same way by any media player that is capable of playing DVD-Video (or equivalent DVD standard) encoded media. That is, once a media program has been produced and encoded on a suitable media, the method of game play may be performed by anyone with a standard media player.

FIG. 3 shows exemplary steps of a method 300 for producing a media program operable to provide an interactive video-game feature. At step 302, a video layer of the media program is produced. The video layer comprises a plurality of video segments. The video segments are linked together in various ways. Some may be linked sequentially, so that when a first segment finishes playing, a second segment begins. Others may be linked by interruption commands that are not activated unless the viewer activates an appropriate command at an appropriate time. The timeline of the video layer, will be synchronized with timelines for a button layer, but the video layer may be an independently produced layer that is later linked to other layers to produce a game feature. It may, be configured as an endless loop that plays continuously until interrupted by a predetermined navigation command or commands.

At least one video segment, when played, shows an animated element that moves relative to the video screen. Any suitable method as known in the art may be used to produce the segments making up the video layer. Exemplary screenshots illustrating frames of an exemplary video layer are discussed later in the specification.

Method 300 further includes a step 304 for defining a button layer of a video segment, and a step 306 for synchronizing the button layer with respect to the video layer. The button layer defines attributes of a plurality of buttons that may be positioned in different screen areas. Attributes that may be controlled include whether or not a button is “highlighted” and the particular navigation command associated with the button. The button layer may be synchronized with the video layer using any suitable authoring program. In an embodiment of the invention, synchronization may be performed by paging through the frames of the video segment, and updating the button layer information to correspond with the animated element's position. The button layer may be synchronized to the video layer, in the sense that the operation of each button of the button layer depends on the position of the animated element at particular times. Each button state is automatically updated as-the video segment plays.

To: provide a visual indication that a particular button is, activated—i.e., its navigation command is “on”—a sub-picture layer may be defined at step 308. The sub-picture layer: may comprise any desired pattern for indicating a highlight. In an embodiment of the invention, the sub-picture layer comprises a translucent pattern of speckles that is visible as a mask over the scene presented by the video layer, without obscuring it. Any suitable translucent pattern or image may be used. In the alternative, the sub-picture mask may be made opaque, for example, in a game in which the object is to uncover a moving element. Accordingly, the effect of the button state on the sub-picture mask will depend on the intended effect. In some embodiments, the button is configured to reveal the sub-picture layer when the button is active. Conversely, in other embodiments, each button may be configured to reveal the sub-picture layer only when the button is not active.

In addition, at step 310, a link to another video segment may be defined. In addition, multiple links to the same or to different video segments may be defined. Each link is configured to operate when an active navigational command associated with one or more buttons of the button layer is activated. For example, if a user sends a designated navigational command while the corresponding button is activated, play of the current video segment will be interrupted, and the linked video segment will begin playing, instead. Links may be defined at the same time as the button layer is defined. Indeed, defining the links associated with buttons may be regarded as a part of defining the button layer.

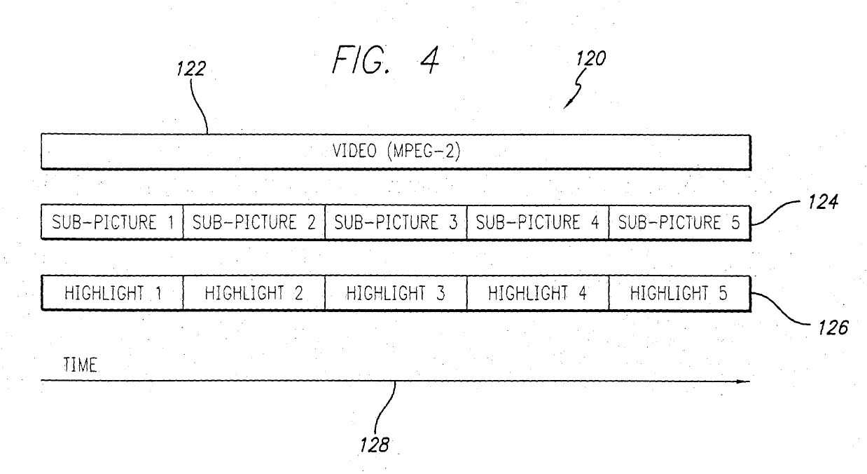

FIG. 4 shows logical relationships of elements of a media program 120 with an interactive game feature, such as may be produced using method 300. Video layer 122 comprises a sequence of video frames that include a background and at least one animated element. The frames are ordered according to a predetermined sequence defining a timeline. The direction of time is shown by arrow 128. Sub-picture layer 124: may comprise a sequence of sub-picture masks (as shown), or a static mask covering the area of the button array. Button layer 126 comprises an activation sequence for buttons of the button layer. For each predefined period of the timeline, e.g., “Highlight 1,” “Highlight 2,” etc., the attributes of each button of the button array are,defined.

Button attributes may include the navigation command for each button and whether or not the button is highlighted. The button attributes are automatically updated as the video layer plays, according to the predetermined synchronization of the button layer that is performed during production. The buttons may be configured'such that, at any moment in time, only one of the buttons “catches” the animated object—i.e., contains a navigation command linking to another segment. The other buttons may be configured to “miss,” for example by containing a null command that has no effect. In other embodiments of the invention, the buttons may be configured differently, depending on the level of complexity desired. For example, different buttons on the same screen may link to different segments.

FIGS. 5-9 below show exemplary screenshots of a video segment of a media program according to an illustrative embodiment of the invention. Each such video segment comprises a sequence of frames, such as exemplary frame 400 shown in FIG. 5. Most or all of the frames in the game segment contain an animated element 402. The frames may be arranged so that element 402 moves continuously across the background 404 in any desired fashion.

Background 404 may generally appear static, or generally in motion, and may itself contain any desired mixture of static and dynamic elements. More than one animated element may be provided, and the game feature may be made responsive to a solitary animated element, to a single one of plural animated elements, or to plural animated elements, as desired. Exemplary animated element 402 is a flying object that flies in a continuous path over the background. Any other mode of motion may also be used for an animated element, or elements. For example, instead of moving continuously, the animated element may jump or crawl from place to place, pausing intermittently.

A revealed region 406 of a speckled sub-picture layer appears in frame 400 to the left of animated element 402. The speckled appearance of the sub-picture layer permits the background 404 underneath it to remain visible. The sub-picture layer may also be given any other desired appearance, either translucent or opaque, so as to indicate that region 406 is highlighted. The sub-picture layer may, in the alternative, comprise a plurality of icons, small graphical images, or even one large image that is gradually “uncovered.” The speckled sub-picture layer-may be hidden except in the highlighted region, as shown. In the alternative, the sub-picture layer may be revealed except in the highlighted region, progressively revealed in response to user input, or handled in any desired way to achieve a desired effect.

In an embodiment of the invention, the game feature is configured such that when the animated element 402 and highlighted region 406 occupy different areas of frame 400, a predetermined navigation command for exiting play of the game loop cannot be executed. Play of initial video segment may continue until a navigation command is executed while the highlighted region 406 and animated element 402 occupy the same region of a frame 400, as shown in FIG. 5.

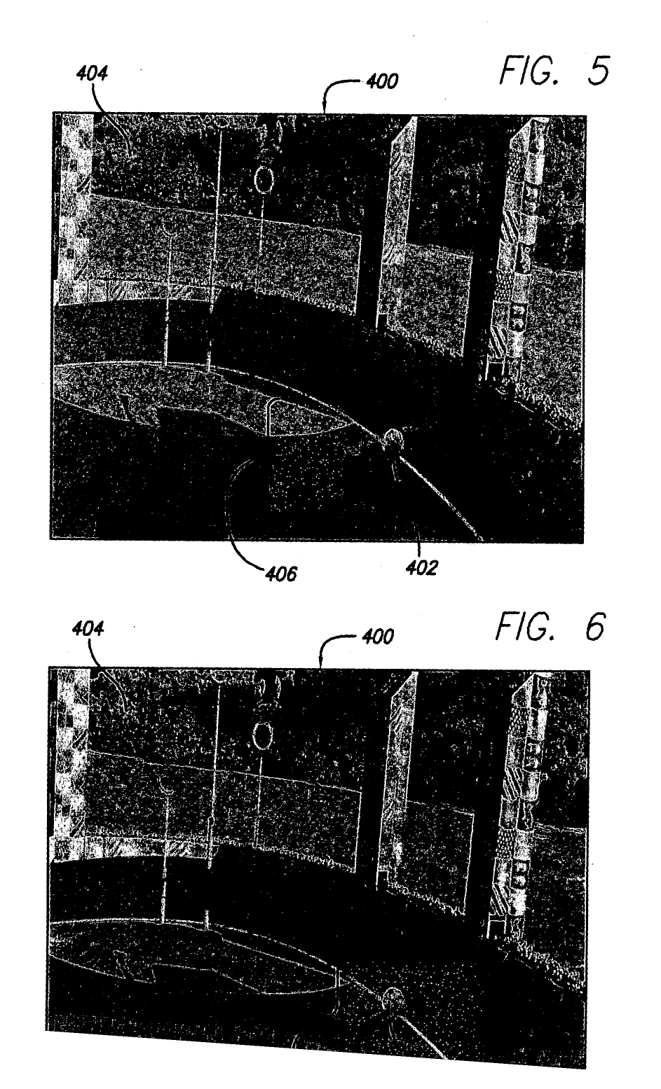

In FIG. 6, the same frame 400 is shown, but with the highlighted region 406 moved over the animated element 402. The position of the highlighted region is determined by the selected button of a button array that resides in a button (highlight) layer. A button may be selected by a user-selection operation on a control device, such as by pressing a cursor movement button, sometimes called an “arrow key.” In effect, the user may chase the animated element with the highlight in video game-like fashion. At the same time, the desired navigation command is configured to move from button to button of the button array, in a predetermined pattern that is synchronized with the movements of the animated element 402. When element 402 and the highlighted region 406 occupy the same area, the desired navigation command is present in the user-selected button. The user may then execute the desired navigation command by using a control device, such as by pressing an “enter” key of a remote control unit, thereby “catching” the animated element. If the user responds too slowly, the animated element will leave the highlighted area, and the desired navigation command will no longer be present. The user may then continue to chase the animated element, or wait for it to re-enter the highlighted region.

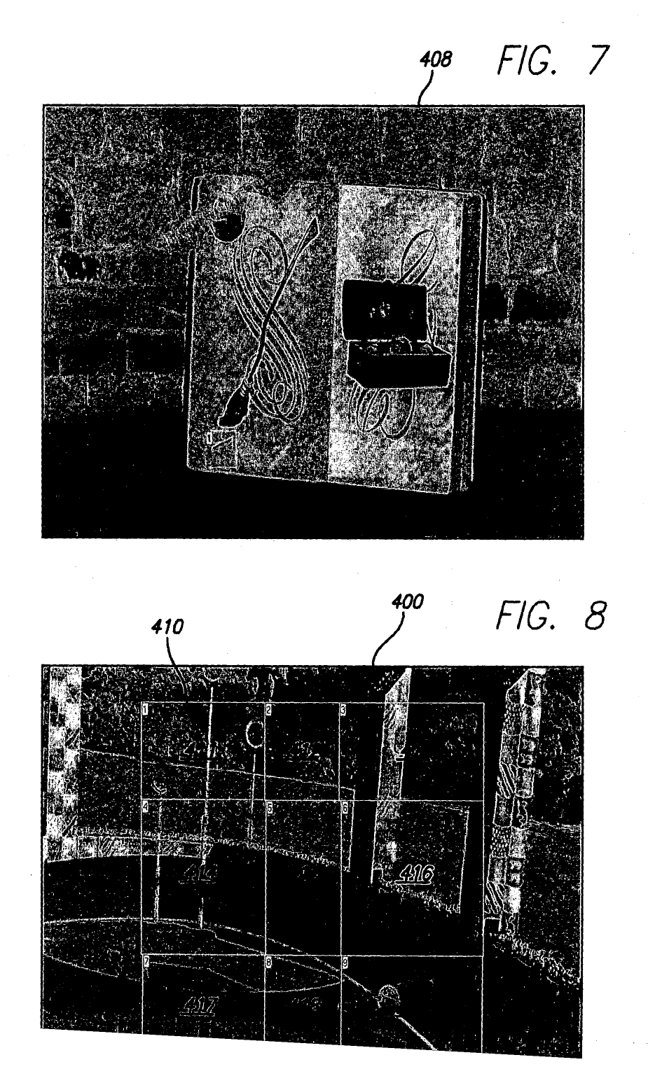

When the navigation command is executed, the original video segment is interrupted, and a second segment may be begun (or the game may be ended). FIG. 7 shows an exemplary frame, 408 from a second segment. The second segment may play as an ordinary video segment, i.e., without a game feature. In the alternative, the second segment may also be configured as a game, thereby providing multiple levels of play. In an alternative embodiment, the navigation command is changed depending on the button location and/or timeline position, so that different segments are entered depending on when and/or where the animated element is “caught.” One of ordinary skill may devise other similar variations within this general game framework. A game comprising any number of desired levels may be constructed.

FIG. 8 shows the video frame 400 of FIG. 4, with a button array 410 revealed. Array 410 comprises nine buttons 411-419. Buttons 411-419 may be the same size, or of different sizes (as shown). While any number of buttons may be used, the DVD-Video Standard allows for a maximum of 36 buttons at any one time for all aspect ratios. So, for example, if the game feature is produced for two aspect ratios—such as 16×9 (wide) and 4×3—two sets of eighteen buttons are allowed, one set for each aspect ratio, for a total of 36 buttons. In the example depicted by Array 410, two sets of nine buttons are used, one for each aspect ratio, for a total of 18 buttons used. Buttons 411-419 may be arranged in any desired pattern. Conversely, if a feature is produced for a single aspect ratio, as many as 36 buttons may be used at a time.

The button array 410 resides in a button (highlight) layer on top of the video layer and the sub-picture layer(s) that contain the highlight mask. Two separate sub-picture layers may be used, with each layer: serving a different display aspect ratio. The video layer may be an MPEG-2 program stream encoded with the Pan Scan bit set, enabling a single video'stream to display in two aspect ratios. The highlight layer contains the attributes for each button 411-419 (colors, commands, navigation, etc.). The button attributes may be used to control which region of the sub-picture layer is visible, for control of button highlighting. The button attributes may be configured so that, at any given time, the viewer sees only that portion of the sub-picture mask demarcated by the currently selected button.

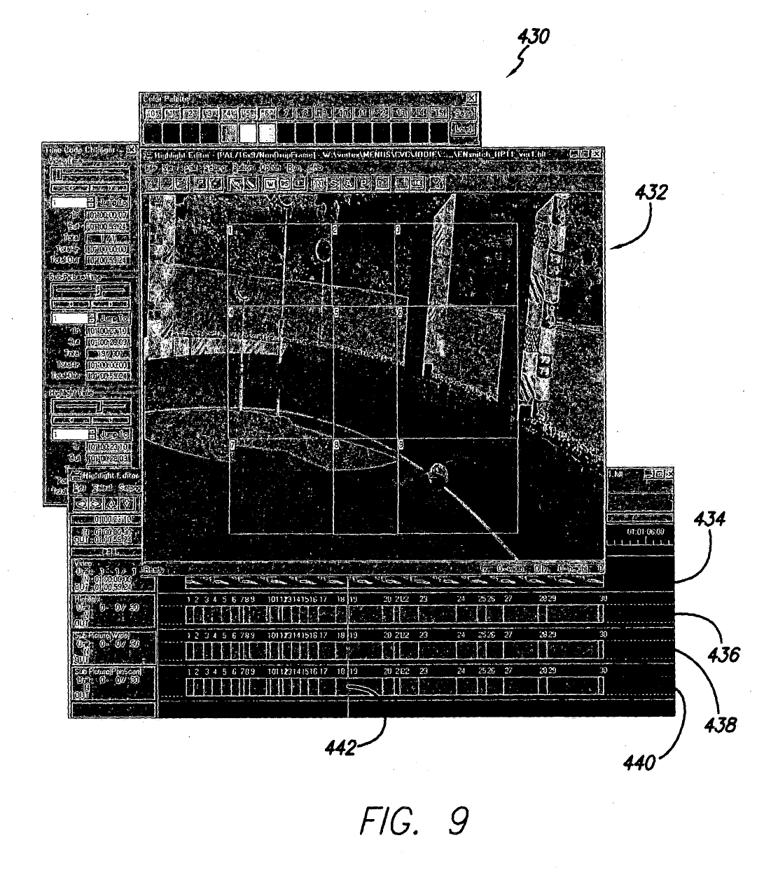

FIG. 9 shows a screen capture 430 from an authoring tool during production of a game feature according to the invention. Window 432 contains a frame of the video layer with the button array of highlight layer revealed, at a time on the program timeline indicated by pointer 442. A frame sequence of the video layer is visible at line 434. An activation sequence of the button layer is visible at line 436. Sub-picture sequences of the sub-picture layers are visible at lines 438, 440. The sub-picture sequences 438, 440 are synchronized with each other, and with the activation sequence of the button layer. One of ordinary skill in the art of DVD authoring and production will recognize various tools available for authoring a game feature according to the invention.

FIG. 10 is a block diagram showing elements of a media program 500 according to the invention. Media program 500 comprises a plurality of video segments 502a-n, with corresponding links 504a-n. Each video segment, for example, video segment 502b, comprises a video layer 506, a button layer 508, and a sub-picture mask layer 510, as described above. Each segment also provides at least one link 504 to another video segment. A final segment (not shown) may be linked to a menu segment for the digital media program, such as a title menu from which the game feature was selected by the user. FIG. 10 shows the segments 502a-n arranged in a simple linear sequence. The first segment links to the second segment, which links to the third segment, and so forth. Advantageously, this may facilitate keeping track of a user's progress through the different segments of the program, because the user's past accomplishments can be determined from the current segment. For example, if the fourth segment is playing, it is known that the user, has successfully passed the first three levels. If desired, this information can be displayed on the screen as a score-keeping feature.

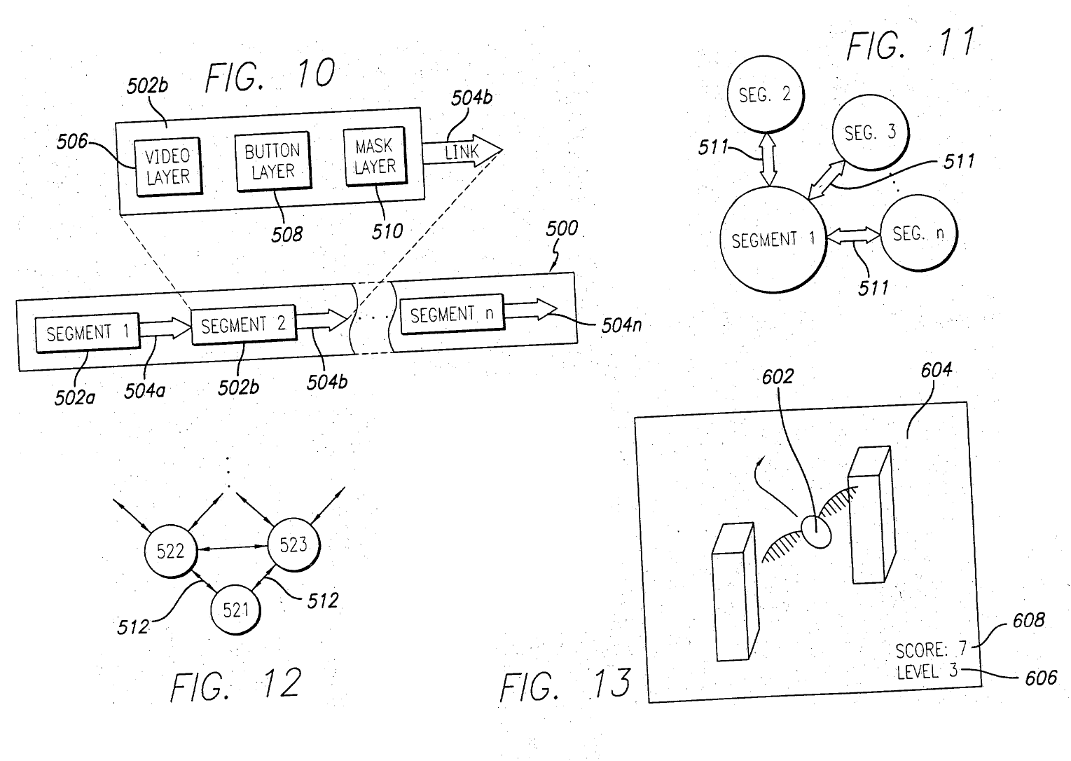

The invention is not limited to a linear sequence of segments within a program. For example, FIG. 11 shows a hub-and-spoke arrangement of segments. Initial segment 1 is, linked to dependent'segments 2-n by a series of two-way links 511. When each of segments 2-n are completed, segment 1 resumes play. Segments may also be linked in a way that combines features of linear linking and hub-and-spoke linking. For example, FIG. 12 illustrate segments 521, 522, and 523 linked by a network of two-way links 512. Each segment provides multiple links to various different segments; the selection of links depends which button is activated when a navigation command is received. This arrangement may provide a richer, more diverse experience for the user, in that different paths may be used to reach a particular segment.

It may be desirable to provide an indicator in the video segments to indicate that a certain level of play or score has been achieved. FIG. 13 shows a video display 600 having an animated element 602 and a background 604. Display 600 further includes an indicator 606 that a certain level of play has been achieved, and a second indicator 608 that a certain score has been achieved. Indicators 606, 608 may be a part of each video segment, and accurate scorekeeping may be maintained when the segments define a determinate path, as described above in connection with FIG. 10. No variable need be assigned for score keeping. In comparison, if multiple paths to a particular segment are possible, score keeping should be performed by updating a variable.

Having thus described a preferred embodiment of a digital media program with an interactive feature for providing a video game-like interactive experience, it should be apparent to those skilled in the art that certain advantages of the within system have :been achieved. It should also be appreciated that various modifications, adaptations, and alternative embodiments thereof may be made within the scope and spirit of the present invention. For example, a method and system for implementation with the DVD-Video standard has been illustrated, but it should be apparent that the inventive concepts described above would be equally applicable to other media standards.

1. A method, for producing a media program with an interactive feature for playing on a DVD-Video player, the method comprising:
defining a video layer of a first video segment, the first video layer comprising information for displaying at least one animated element moving relative to a display area;
defining a button layer of the first video segment, the button layer comprising a plurality of buttons each overlaying different areas of the display area, wherein a command for interrupting play of the first video segment is associated with the plurality of buttons;
associating the command for interrupting play with respective ones of the plurality of buttons for periods determined by the animated element's position in the display area.

2. The method of claim 1, further comprising defining a second video segment for play after the first video segment is interrupted by an activated command, the second video segment comprising a video layer and a button layer synchronized to the video layer so as to activate a command for interrupting play of the second video segment.

3. The method of claim 2, wherein the defining a second video segment step further comprises defining the second video segment step including an indicator indicating that a higher level of play has been achieved.

4. The method of claim 2, wherein the defining a second video segment step further comprises defining the second video segment comprising a numeric indicator indicating that a certain score has been achieved.

5. The method of claim 1, further comprising defining a second video segment for play after the first video segment is interrupted by an activated command, the second video segment lacking a button layer.

6. The method of claim 1, further comprising defining a plurality of video segments each comprising a video layer and a button layer synchronized to the video layer so as to activate a command for interrupting play of the each video segment; and
defining a link for each of the plurality of video segments, each link causing one of the plurality of video segments to begin when another of the plurality of video segments is interrupted by an activated command.

7. The method of claim 1, further comprising defining a mask layer with regions overlying the different areas of the display area, the mask layer synchronized with the button layer, whereby selection of a button of the plurality of buttons causes a corresponding region of the mask layer to be displayed.

8. A method for playing an interactive game using a DVD-Video player connected to a display device and to a pointing device, the display device displaying a first video segment comprising at least one animated element moving through different regions of a display area, the method comprising:
playing the first video segment;
receiving a pointing input from the pointing device;
designating an active region of the different regions of the display area in response to the pointing input;
receiving an interruption command; and
interrupting the first video segment by playing a second video segment, if the at least one animated element is in a predetermined relationship to the active region when the interrupting command is received.

9. The method of claim 8, wherein the pointing device comprises a keypad having arrow keys, and wherein the first receiving step further comprises receiving the pointing input determined from actuation of the arrow keys.

10. The method of claim 8, Wherein the designating step further comprises de-activating the active region in response to input from a pointing device, and then designating a different active region.

11. The method of claim 8, further comprising playing the second video segment, and then resuming play of the first video segment after the second video segment terminates.

12. The method of claim 8, further comprising playing the second video segment, the second video segment comprising at least one animated element moving through different regions of a display area;
receiving a pointing input from the pointing device so as to designate an active region of the different regions of the display area during play of the second video segment;
receiving the interruption command during play of the second video segment, and
interrupting the second video segment by playing a third video segment, if the at least one animated element is in a predetermined relationship to the active region when the interrupting command is received.

13. The method of claim 12, wherein the playing the second video step further comprises playing the second video segment comprising an indicator indicating that a higher level of play has been achieved.

14. The method of claim 12, wherein the playing the second video step further comprises playing the second video segment comprising a numeric indicator indicating that a certain score has been achieved.

15. An optical media article of the group selected from a disc and a tape, the article comprising information encoded in a DVD-standard format, the information comprising:
a video layer of a first video segment, the first video layer comprising information for displaying at least one animated element moving relative to a display area;
a button layer of the first video segment, the button layer comprising a plurality of buttons each overlaying different areas of the display area;
a command for interrupting play of the first video segment, the command associated with respective ones of the plurality of buttons for periods determined by the animated element's position in the display area.

16. The optical media of claim 15, wherein the information further comprises a second video segment for play after the first video segment is interrupted by an activated command, the second video segment comprising a video layer and a button layer synchronized to the video layer so as to activate a command for interrupting play of the second video segment.

17. The optical media of claim 15, wherein the information further comprises a second video segment for play after the first video segment is interrupted by an activated command, the second video segment lacking a button layer.

18. The optical media of claim 15, wherein the information further comprises a plurality of video segments each comprising a video layer and a button layer synchronized to the video layer so as to activate a command for interrupting play of the each video segment; and
a link for each of the plurality of video segments, each link causing one of the plurality of video segments to begin when another of the plurality of video segments is interrupted by an activated command.

19. The optical media of claim 15, wherein the information further comprises an indicator in each of the plurality of video segments, each indicator indicating a level of play achieved by a user when the each of the plurality of video segments is played.

20. The optical media of claim 15, wherein the information further comprises a mask layer with regions overlying the different areas of the display area, the mask layer synchronized with the button layer, whereby selection of a button of the plurality of buttons causes a corresponding region of the mask layer to be displayed.
